(19) United States
(12) Patent Application Publication
(10) Pub. No.: US 2024/0338699 A1
(43) Pub. Date: Oct. 10, 2024

(54) CONFIGURING BLOCKCHAIN WALLET WITH SECURED SEED PHRASE

(71) Applicant: SatSaver LLC, Wichita Falls, TX (US)

(72) Inventors: Brian Fosse, Spearfish, SD (US); John Lott, Wichita Falls, TX (US); Daniel Herbert, Seattle, WA (US); Zachary West, Seattle, WA (US); Hedvig Maria Beetz von Beetzen, Vashon, WA (US)

(73) Assignee: SatSaver LLC, Wichita Falls, TX (US)

(21) Appl. No.: 18/627,939

(22) Filed: Apr. 5, 2024

Related U.S. Application Data
(60) Provisional application No. 63/457,324, filed on Apr. 5, 2023.

(51) Int. Cl. G06Q 20/40; G06Q 20/36

(52) U.S. Cl. CPC G06Q 20/4012; G06Q 20/3674

(57) ABSTRACT

In general, various embodiments of the present invention provide methods, apparatuses, systems, computing devices, computing entities, and/or the like for configuring a blockchain wallet. Various embodiments involve generating a legitimate seed phrase that comprises a sequence of legitimate words; identifying, based on a PIN word, a starting position within an encrypted seed phrase of a first word found in a first position in the legitimate words, a position of at least one decoy word within the encrypted seed phrase, and a direction in which the legitimate words proceeds within the encrypted seed phrase; generating the encrypted seed phrase that comprises the first word in the starting position, the decoy word in the position, and the legitimate words proceeding in the direction to form a sequence of encrypted words; and configuring, based at least in part on the legitimate seed phrase, a blockchain wallet to access cryptocurrency funds for an individual.

### CROSS-REFERENCE TO RELATED APPLICATIONS

This application claims priority from U.S. Provisional patent Application Ser. No. 63/457,324, filed Apr. 5, 2023, entitled “CONFIGURING BLOCKCHAIN WALLET WITH SECURED SEED PHRASE,” which is hereby incorporated herein by reference in its entirety.

### TECHNICAL FIELD

The present disclosure is generally related to data processing systems and methods for establishing original operating parameters for a digital data processing system, and more specifically establishing a secure seed phrase for a blockchain wallet.

### BACKGROUND

Cryptocurrency and digital property, such as Bitcoin, is a savings technology with individual property rights. Engineered to hold value in the long-term, it has a fixed monetary schedule. For example, the number of Bitcoins created each block is halved every 210,000 blocks that are mined. This happens roughly every four years. With only twenty-one million total that will ever be made, this makes Bitcoin deflationary as it is designed to increase in value over time as supply issuance decreases and demand increases. For this reason, cryptocurrency with fixed monetary schedules can be viewed as having premium property, but with no property taxes or maintenance upkeep.

Further, Bitcoin can be taken anywhere in the world and transferred to anyone anywhere in the world without a trusted third party or middleman, in seconds. Therefore, Bitcoin is designed to have a finite supply (is scarce), is censorship resistant (no government, bank or third party to approve use), borderless (can be sent/received worldwide in seconds), zero cost of ownership (an individual can have self-custody for free), and zero time decay (does not lose value through inflation over time). Accordingly, there is a need for improved systems and methods for insuring the security of an individual's Bitcoins and other digital property.

### SUMMARY

In general, various aspects of the present disclosure provide methods apparatuses, systems, computing device, computing entities, and/or the like for configuring and/or accessing blockchain wallets in a secure manner. In accordance with various aspects, a method is provided. In still other aspects, a system is provided comprising a non-transitory computer-readable medium storing instructions and a processing device communicatively coupled to the non-transitory computer-readable medium. The processing device, in various aspects, is configured to execute the instructions and thereby perform one or more operations including at least some of those described with respect to one or more methods described herein. In still other aspects, a non-transitory computer-readable medium storing computer-executable instructions is provided. The computer-executable instructions, when executed by computing hardware, configure the computing hardware to perform one or more operations described with respect to one or more methods described herein. A method, in various aspects, comprises: (1) generating a legitimate seed phrase, wherein the legitimate seed phrase comprises a sequence of legitimate words; (2) identifying, based on a PIN word, a starting position within an encrypted seed phrase of a first word found in a first position in the sequence of legitimate words; (3) identifying, based on the PIN word, at least one position of at least one decoy word within the encrypted seed phrase; (4) identifying, based on the PIN word, a direction in which the sequence of legitimate words proceeds within the encrypted seed phrase; (5) generating the encrypted seed phrase, wherein the encrypted seed phrase comprises the first word found in the first position in the sequence of legitimate words in the starting position, the at least one decoy word in the at least one position, and the sequence of legitimate words proceeding in the direction to form a sequence of encrypted words; and (6) configuring, based at least in part on the legitimate seed phrase, a blockchain wallet to access cryptocurrency funds for an individual via the legitimate seed phrase.

In various embodiments, the method further comprises: (1) decrypting, based on the PIN word, the encrypted seed phrase to identify the sequence of legitimate words for the legitimate seed phrase; and (2) accessing, based on the legitimate seed phrase, the cryptocurrency funds through the blockchain wallet. In other aspects: (1) the sequence of encrypted words comprises a sequence of twenty-six words, (2) the sequence of legitimate words comprises a sequence of twenty-four words, (3) the at least one decoy word comprises two decoy words, and (4) the encrypted seed phrase comprises: (A) the sequence of twenty-six words that comprise the sequence of twenty-four words with the two decoy words embedded within the sequence of twenty-four words, (B) the starting position containing the first word found in the first position in the sequence of twenty-four words; and (C) the sequence of twenty-four words proceeds within the sequence of twenty-six words in the direction. In a particular embodiment, each position of the sequence of twenty-six words corresponds to a letter of an alphabet, the starting position is based on a first letter of the PIN word, and the PIN word comprises at least two letters. In various embodiments, a position of the first decoy word in the sequence of twenty-six words is based on a second letter of the PIN word, and a position of the second decoy word in the sequence of twenty-six words is based on a last letter of the PIN word. In some aspects, the direction in which the sequence of twenty-four words proceeds within the sequence of twenty-six words is forward if the PIN word includes an even number of letters or back ward if the PIN word includes an odd number of letters.

A method, in various aspects comprises: (1) receiving, by computing hardware, a first seed phrase comprising a first set of words in a first order; (2) receiving, by the computing hardware, a PIN word; (3) modifying, by the computing hardware, the first seed phrase into a second seed phrase by: (A) identifying, based on at least one letter in a first position of the PIN word, a second set of words from the first set of words, the second set of words comprising at least one fewer word than the first set of words; (B) determining, based on at least one second letter in a second position of the PIN word, a second order for the second set of words; and (C) generating, by the computing hardware based on the PIN word, the second seed phrase comprising the second set of words in the second order; and (4) enabling, by the computing hardware, access to a blockchain wallet through operation of the second seed phrase. In particular aspects, receiving the first seed phrase comprises: (1) receiving an image; and (2) analyzing the image using one or more optical character recognition techniques to identify the first seed phrase in the image.

In some aspects, analyzing the image using one or more optical character recognition techniques to identify the first seed phrase in the image comprises: (1) analyzing the image to identify a first column of words and a second column of words adjacent the first column of words; and (2) extracting the first seed phrase from the first column of words and the second column of words. In various aspects, determining, based on the at least one second letter in the second position of the PIN word, the second order for the second set of words comprises arranging the second set of words beginning with a first word identified by the at least one second letter and arranging the second set of words in a direction defined by a number of letters in the PIN word. In other aspects, identifying the second set of words from the first set of words, comprises omitting at least one word from the first set of words in a position defined by that at least one letter in the first position. In particular embodiments, the first set of words comprises twenty six words and the second set of words comprises twenty four words. In some aspects, enabling, by the computing hardware, access to the blockchain wallet through operation of the second seed phrase comprises providing the second seed phrase to the blockchain wallet. In still other aspects, enabling, by the computing hardware, access to the blockchain wallet through operation of the second seed phrase displaying the second seed phrase on a display screen of a computing device.

A kit for use in generating an encrypted seed phrase, according to various embodiments, comprises: (1) a set of instructions; (2) a saver card comprising a first stack of parallel lines and a second stack of parallel lines spaced apart from the first stack of parallel lines, wherein: (A) the first stack of parallel lines is parallel to the second stack of parallel lines; and (B) the saver card defines a fold between the first stack of parallel lines and the second stack of parallel lines; (3) one or more practice cards, at least a portion of each of the one or more practice cards duplicating at least a portion of the saver card; and (4) packaging configured to receive the set of instructions, the saver card, and the one or more practice cards, wherein the kit is configured to enable a user to generate the encrypted seed phrase according to the set of instructions by: (1)

generating an initial seed phrase; (2) selecting at least one decoy word; (3) selecting a PIN word; (4) encrypting the initial seed phrase by inserting the at least one decoy word into the initial seed phrase at a position defined by the PIN word; (5) rearranging the initial seed phrase including the at least one decoy word into an order defined by the PIN word to form the encrypted seed phrase; and (6) recording the encrypted seed phrase on the saver card by writing each word of the encrypted seed phrase on a respective line of first stack of parallel lines and the second stack of parallel lines.

In various aspects, the first stack of parallel lines and the second stack of parallel lines comprise thirteen parallel lines. In particular aspects, the at least one decoy word comprises two decoy words. In some aspects, the encrypted seed phrase comprises twenty six words. In various embodiments, the packaging defines a first slot configured to receive the saver card and a second slot configured to receive the set of instructions. In a particular embodiment, the saver card, when folded along the fold between the first stack of parallel lines and the second stack of parallel lines is sized, shaped, and dimensioned approximately like a credit card.

### BRIEF DESCRIPTION OF THE DRAWINGS

In the course of this description, reference will be made to the accompanying drawings, which are not necessarily drawn to scale, and wherein:

FIG. 1 depicts an example of a process for configuring a blockchain wallet with a seed phrase in accordance with various embodiments of the present disclosure;

FIG. 2 depicts an example of a process generating a seed phrase in accordance with various embodiments of the present disclosure;

FIGS. 3A-3D depict an example of a worksheet for generating an encrypted seed phrase in accordance with various embodiments of the present disclosure;

FIGS. 4A-4C depict an example of an encryption kit packaging in accordance with various embodiments of the present disclosure;

FIGS. 5A-5G depict examples of types of an encryption kit and seed phrase saver cards in accordance with various embodiments of the present disclosure;

FIG. 6 depicts an example of a system architecture that may be used in accordance with various embodiments of the present disclosure;

FIG. 7 depicts an example of a computing entity that may be used in accordance with various embodiments of the present disclosure;

FIG. 8 depicts an example of a process for configuring a blockchain wallet with a seed phrase in accordance with yet another embodiment of the present disclosure; and

FIGS. 9A-9G depict examples of various components of an encryption kit in accordance with various embodiments of the present disclosure.

### DETAILED DESCRIPTION

### Overview and Technical Contributions of Various Embodiments

A blockchain wallet can be used in accessing an individual's cryptocurrency funds, Bitcoin, digital assets, and/or the like (referred to throughout as cryptocurrency, cryptocurrency funds, or simply funds). A blockchain wallet does not technically store the individual's cryptocurrency funds, but provides access to the funds by storing the keys to transact the funds. Unlike a conventional bank account, cryptocurrency is not tied to an individual's identity. Instead the individual's cryptocurrency funds are stored on a blockchain (e.g., ledger) that records all the transactions that occur. Therefore, when setting up a blockchain wallet for holding an individual's cryptocurrency funds, a string (sequence) of words known as a seed phrase is provided that can then be used to access the funds in the wallet. Furthermore, the seed phrase can be used to recover the cryptocurrency funds if the blockchain wallet is lost or damaged. For example, if an individual accidentally damages or loses his or her hardware wallet or device (e.g., mobile device) with their software wallet, then the individual can use the seed phrase to set up a new wallet and his or her cryptocurrency funds will then be available through the new wallet.

However, technical challenges arise with managing transfer of cryptocurrency funds on a blockchain platform through the use of a seed phrase. Since cryptocurrency funds are tied to the seed phrase and not an individual, anyone who knows an individual's seed phrase can transfer the individual's cryptocurrency funds on the blockchain platform without authorization from or control by the individual. Furthermore, the individual can only transfer his or her cryptocurrency funds on the blockchain platform by using his or her seed phrase. Therefore, if the individual loses or forgets his or her seed phrase, then the individual may permanently lose the ability to transfer to his or her cryptocurrency funds on the blockchain platform. Thus, it is crucial that an individual securely store his or her seed phrase to prevent the phrase from being accessed by unintended parties. In addition, it is crucial that an individual securely store his or her seed phrase to prevent the possibility of loss. Accordingly, various embodiments of this disclosure address these technical challenges by providing technical solutions for configuring a blockchain wallet with a seed phrase that allows for multiple copies of an individual's seed phrase to be produced, while also preventing disclosure of the seed phrase to unintended parties.

Still further aspects of this disclosure address technical challenges related to the security of blockchain wallets. In particular, various aspects address technical challenges related to limiting unwanted accesses to the blockchain wallets, while preventing potential catastrophic permanent loss of access (e.g., through too large a number of incorrect seed phrase entries by a wallet user). Particular aspects of the present disclosure address technical challenges related to a need to memorialize a seed phrase in a secure form that enables the phrase in its secure form to enable a user to easily provide the phrase for accessing the blockchain wallet when needed. For example, various aspects of the present disclosure may apply a set of rules to a provided seed phrase in order to modify the seed phrase for providing the seed phrase for accessing the blockchain wallet. In this way, the set of rules may define how the seed phrase is modified for accessing the blockchain wallet in order to enable a user to store the provided seed phrase openly (e.g., in plain text). In various aspects, a system described herein is configured to modify the seed phrase according to a passphrase/pin word, which may, for example, define how the provided seed phrase is modified for accessing the blockchain wallet. Still other aspects of the present disclosure address technical challenges related to blockchain wallet security by providing improved techniques for securing a seed phrase against undesired use while providing a straightforward manner in which a user may ‘unscramble’ a coded seed phrase for use in accessing a blockchain wallet. For example, various aspects of the present disclosure provide improved techniques for decoding a scrambled seed phrase that reduce time-consuming, cumbersome operations related to modifying a recorded seed phrase (e.g., a recorded seed phrase in scrambled form).

### Configure Blockchain Wallet Module

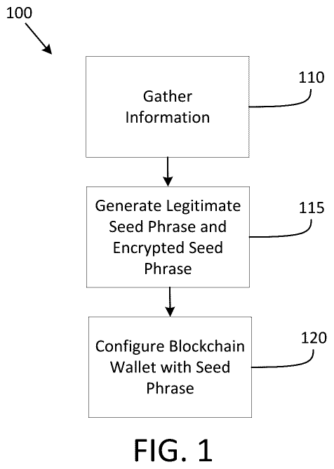

Turning to FIG. 1, additional details are provided regarding a configure blockchain wallet module for configuring a blockchain wallet with a seed phrase to be used to access cryptocurrency funds through the wallet in accordance with various embodiments of the disclosure. For instance, the flow diagram shown in FIG. 1 may correspond to operations carried out, for example, by computing hardware as described herein, as the computing hardware executes the configure blockchain wallet module. In other aspects, the steps of FIG. 1 may correspond to method steps performed in order to code and/or decode a seed phrase for use with a blockchain wallet.

The blockchain wallet may be a certain type of blockchain wallet such as a hardware wallet, software wallet, and/or the like. Typically, a setup module is provided along with the blockchain wallet that allows for an individual (e.g., “owner” of the wallet) to set up the wallet so that he or she can use the wallet for storing cryptocurrency funds. In doing so, the setup module may request the individual to provide a seed phrase that is to be used in accessing cryptocurrency funds through the blockchain wallet, as well as to be used to recover the cryptocurrency funds through a new blockchain wallet if the wallet is damaged or lost.

In various embodiments, the configure blockchain wallet module is configured to operate in conjunction with the setup module to configure the blockchain wallet with the seed phrase. For example, the configure blockchain wallet module may communicate with the setup module via an application programming interface (API). Here, the configure blockchain wallet module may provide the setup module with the seed phrase when requested so that the setup module can then configure the blockchain wallet accordingly. In another example, the configure blockchain wallet module may output the seed phrase that the individual can then provide to the setup module. Here, the configure blockchain wallet module may operate as a stand-alone module from the setup module and output the seed phrase through some type of electronic mechanism such as an interface, electronic communication such as an email, printed document, and/or the like.

The process 100 begin in Operation 110 with the configure blockchain wallet module gathering information needed in generating the seed phrase and an encrypted version of the seed phrase (also referred to as an encrypted seed phrase). In particular embodiments, the configure blockchain wallet module performs this operation by providing the individual with one or more interfaces (e.g., graphical user interfaces) for requesting information from the individual that is then used in generating the seed phrase and encrypted seed phrase. For example, as discussed in further detail herein, the configure blockchain wallet module may request the individual to select the words that are used in creating the seed phrase. In addition, the configure blockchain wallet module may request the individual to provide one or more decoy words that are used in creating the encrypted seed phrase. Further, the configure blockchain wallet module may request a PIN word that is used in encrypting the seed phrase to generate the encrypted seed phrase.

Once the configure blockchain wallet module has gathered the needed information, the configure blockchain wallet module generates the seed phrase and the encrypted seed phrase in Operation 115. As discussed in further detail herein, the configure blockchain wallet module performs this particular operation in various embodiments by invoking a generate seed phrase module. In turn, the generate seed phrase module uses the information provided by the individual such as the words to include in the seed phrase, the decoy words, the PIN word, and/or the like to generate the seed phrase and encrypted seed phrase.

At this point, the configure blockchain wallet module configures the blockchain wallet with the seed phrase in Operation 120. As previously noted, the configure blockchain wallet module may perform this operation differently depending on the embodiment. In one embodiment, the configure blockchain wallet module may interface with the setup module for the blockchain wallet and provide the setup module directly with the seed phrase that the setup module then uses to configure the blockchain wallet. In another embodiment, the configure blockchain wallet module may output the seed phrase (as well as the encrypted seed phrase) to the individual, who then enters the seed phrase into the setup module to configure the blockchain wallet.

For example, the configure blockchain wallet module may display the seed phrase via an interface (e.g., graphical user interface) to the individual. In another example, the configure blockchain wallet module may send the seed phrase in some type of electronic communication such as an email to the individual. Yet, in another example, the configure blockchain wallet module may print out the seed phrase via a printer to produce one or more hardcopies of the seed phrase. Accordingly, the configure blockchain wallet module may do the same for the encrypted seed phrase, PIN word, decoy words, and/or the like. Further, the configure blockchain wallet module may perform any combination thereof with respect to the seed phrase, encrypted seed phrase, PIN word, decoy words, and/or the like. For example, the configure blockchain wallet module may provide the seed phrase directly to the setup module, print one or more hardcopies of the encrypted seed phrase, and print one or more hardcopies of the PIN word for the individual.

### Generate Seed Phrase Module

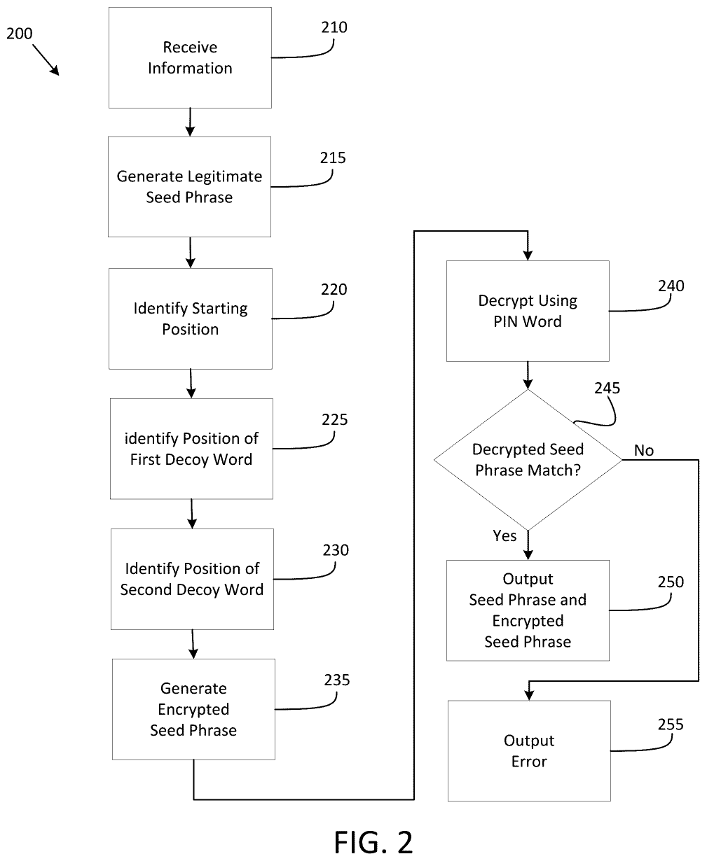

Turning to FIG. 2, additional details are provided regarding a generate seed phrase module for generating a seed phrase and an encrypted version of the seed phrase (encrypted seed phrase) to be used in configuring a blockchain wallet in accordance with various embodiments of the disclosure. For instance, the flow diagram shown in FIG. 2 may correspond to operations carried out, for example, by computing hardware as described herein, as the computing hardware executes the generate seed phrase module.

As previously noted, the configure blockchain wallet module invokes the generate seed phrase module in various embodiments to have the generate seed phrase module generate a seed phrase and encrypted seed phrase used in securely configuring an individual's blockchain wallet. While in other embodiments, the configure blockchain wallet module may be invoked by a different module (e.g., a setup module for the blockchain wallet) and/or executed as a stand-alone module to generate the seed phrase and encrypted seed phrase.

Accordingly, the configure blockchain wallet module, generate seed phrase module, or other module may solicit information from the individual that is used in generating the seed phrase and encrypted seed phrase. For example, the module may provide one or more interfaces (e.g., graphical user interfaces) that solicit the information from the individual. For example, an interface may solicit the words to use in the seed phrase from the individual. As a specific example, a seed phrase is typically comprised of a sequence of twelve or twenty-four words. Therefore, the interface may solicit the individual to indicate the twelve or twenty-four words to use in building the sequence for the seed phrase. In some embodiments, the interface may provide a listing of potential seed phase words (e.g., BIP39 listing) and allow for the individual to select the twelve or twenty-four words from the listing. In some embodiments, the interface may randomly generate the twelve or twenty-four words if desired by the individual.

In addition, an interface may solicit a passphrase from the individual. A seed phrase can also include a passphrase to create a two-factor seed phrase. The passphrase can act as a type of password that is required by the blockchain wallet along with the correct initial sequence of words to allow access to the individual's cryptocurrency funds through the wallet. Again, the interface may provide the individual with a listing of passphrases and allow for the individual to select the passphrase to use from the listing. Further, the interface may generate the passphrase if desired by the individual. Further, the individual can designate any combination of characters to act as the additional passphrase.

In addition, an interface may solicit decoy words from the individual to use in generating the encrypted seed phrase. Again, the interface may provide the individual with a listing of potential decoy words and allow for the individual to select the decoy words to use from the listing. Further, the interface may generate the decoy words if desired by the individual. Furthermore, an interface may solicit a PIN word from the individual to use in generating the encrypted seed phrase. For example, the interface may solicit a PIN word that has at least two letters. Again, the interface may provide the individual with a listing of potential PIN words to select from, as well as generate a PIN word if desired by the individual. In some embodiments, the interface may allow the individual to indicate to use a single word as both the passphrase and the PIN word if desired.

Therefore, the process 200 begins with the generate seed phrase module receiving the information provided by (and/or generated for) the individual in Operation 210. In Operation 215, the generate seed phrase module generates the legitimate seed phrase in Operation 215 based on the information. As noted, a seed phrase is typically comprised of twelve or twenty-four words, although other sized sets of words can be used. A seed phrase comprising twenty-four words is discussed throughout the remainder of this disclosure.

Here, the generate seed phrase module arranges the set of words identified by the individual into a sequence (e.g., particular order) of legitimate words. In some embodiments, the individual may identify the sequence, or may identify the position of one or more words in the sequence. In some embodiments, the generate seed phrase module may generate the sequence of legitimate words, or may generate at least a portion of the sequence of legitimate words as directed by the individual. Accordingly, the legitimate seed phrase comprises the sequence of legitimate words with each legitimate word having a defined position in the sequence. For example, for a twenty-four legitimate seed phrase, the legitimate seed phrase comprises a sequence of twenty-four legitimate words with each legitimate word having a position defined within one to twenty-four. In addition, the generate seed phrase module can add the passphrase to create a two-factor legitimate seed phrase. Specifically, the generate seed phrase module can add the passphrase so that the passphrase can be employed along with the sequence of twenty-four legitimate words to act as a new seed phrase of twenty-five words that can be used for validating transactions on the blockchain.

Once the generate seed phrase module has generated the legitimate seed phrase, the generate seed phrase generates the encrypted seed phrase based on the legitimate seed phrase and other information provided by (and/or generated for) the individual. In various embodiments, the encrypted seed phrase is made up of the legitimate seed phrase with one or more embedded decoy words. For example, the encrypted seed phrase may include the legitimate seed phrase with two decoy words embedded somewhere within the sequence of legitimate words that make up the legitimate seed phrase. Therefore, in this example, the encrypted seed phrase comprises a sequence of twenty-six words with the sequence of twenty-four legitimate words having two decoy words embedded within the sequence.

At Operation 220, the generate seed phrase module identifies a starting position at which the sequence of legitimate words for the legitimate seed phrase begins in the encrypted seed phrase. In various embodiments, the generate seed phrase module uses the PIN word to identify the starting position. For example, the encrypted seed phrase may comprise twenty-six words and therefore, include twenty-six positions. Each position of the encrypted seed phrase corresponds to a letter of the English alphabet (A=1, Z=26). Therefore, the generate seed phrase module may use the first letter of the PIN word to identify the position in the encrypted seed phrase for the first legitimate word found in the legitimate seed phrase.

In Operation 225, the generate seed phrase module identifies the position of the first decoy word that is placed in the encrypted seed phrase. In particular embodiments, the generate seed phrase module may use the second letter of the PIN word to identify the position in the encrypted seed phrase for the first decoy word. In Operation 230, the generate seed phrase module identifies the position of the second decoy word that is placed in the encrypted seed phrase. In particular embodiments, the generate seed phrase module may use the last letter of the PIN word to identify the position in the encrypted seed phrase for the second decoy word. Further, in particular embodiments, the generate seed phrase module uses the length of the PIN word to determine whether the sequence of legitimate words proceeds in a forward or backward direction in the sequence of words for the encrypted seed phrase. For example, the generate seed phrase module may determine that the sequence of legitimate words proceeds in a forward direction if the PIN word includes an even number of letters or a backward direction if the PIN word includes an odd number of letters. Once the generate seed phrase module identifies the starting position at which the sequence of legitimate words begins, the position of the first decoy word, and the position of the second decoy word, the generate seed phrase module generates the encrypted seed phrase in Operation 235.

As a result, for the encrypted seed phrase, the PIN word can be used in identifying a starting position for the sequence of legitimate words, the two decoy words, and provide the ability to read the sequence of legitimate words in a forward or backward direction from the starting position. Therefore, the PIN word serves as a secure key that can be used to decrypt the encrypted seed phrase to correctly access the legitimate seed phrase. For example, using a PIN word that includes at least two letters and an encrypted seed phrase with twenty-six positions and two decoy words can allow for over three billion combinations for the decrypted sequence of twenty-four words that make up the legitimate seed phrase with the passphrase.

As an example, the PIN word “pizza” would indicate that the start of the sequence of legitimate words is at position sixteen, the two decoy words are found in positions nine and one, and the sequence of legitimate words proceeds in a backward direction. As another example, the PIN word “two” would indicate that the start of the sequence of legitimate words is at position twenty, the two decoy words are found in positions twenty-three and fifteen, and the sequence of legitimate words proceeds in a backward direction. As another example, the PIN word “levi” would indicate that the start of the sequence of legitimate words is at position twelve, the two decoy words are found in positions five and nine, and the sequence of legitimate words proceeds a forward direction.

As another example, the PIN word “at” would indicate that the start of the sequence of legitimate words is at position one, the two decoy words are found in positions twenty and twenty-six, and the sequence of legitimate words proceeds a forward direction. In this example, the second decoy word is in position twenty-six because the sequence of legitimate words is reached at position twenty-five. Yet, as another example, the PIN word “torro” would indicate that the start of the sequence of legitimate words is at position twenty, the two decoy words are found in positions fifteen and twenty, and the sequence of legitimate words proceeds a backward direction. In this example, the second decoy word is in position twenty-one because the sequence of legitimate words is reached at position twenty-two. This is what happens when second and last letters of the PIN word are the same. Yet, in another example, the PIN word “abba” would indicate that the start of the sequence of legitimate words is at position one, the two decoy words are found in positions two and one, and the sequence of legitimate words proceeds a forward direction. In this example, one would start with the first position, but the first position is a decoy word, so the first legitimate word is found in position three.

Returning to the process 200, the generate seed phrase module decrypts the encrypted seed phrase using the PIN word in Operation 240. The generate seed phrase module performs this operation in particular embodiments to confirm that the encrypted seed phrase was correctly constructed. Therefore, in Operation 245, the generate seed phrase module determines whether the decrypted seed phrase matches the legitimate seed phrase. If not, then the generate seed phrase module outputs an error in Operation 255. For example, the generate seed phrase module outputs the error as a message displayed on an interface.

However, if the decrypted seed phrase matches the legitimate seed phrase, then the generate seed phrase module outputs the legitimate seed phrase and encrypted seed phrase in Operation 250. In addition, the generate seed phrase module may output additional information such as the passphrase, the PIN word, and/or the like. The generate seed phrase module may output the legitimate seed phrase and encrypted seed phrase in various ways depending on the embodiment. In some embodiments, the generate seed phrase module outputs the legitimate seed phrase and encrypted seed phrase to another module such as the configure blockchain wallet module as previously discussed. In some embodiments, the generate seed phrase module outputs the legitimate seed phrase and encrypted seed phrase to an interface for display. In some embodiments, the generate seed phrase module outputs the legitimate seed phrase and encrypted seed phrase in some type of electronic communication and/or to some type of printing device. In some embodiments, the generate seed phrase module outputs the legitimate seed phrase and encrypted seed phrase via some type of combination of these mechanisms. At this point, the legitimate seed phrase can be used to configure the blockchain wallet, and the encrypted seed phrase can be used to store and recover the seed phrase in a secure manner.

### Encryption Kit

A major advantage of various embodiments of the disclosure is that the process for encrypting the legitimate seed phrase can allow for self-custody of an individual's blockchain wallet (and corresponding digital assets thereof) and to store his or her legitimate seed phrase for the blockchain wallet in a secure manner. This can allow the individual to provide the encrypted seed phrase to multiple individuals for safe keeping, and still have the legitimate seed phrase secure from discovery by those individuals.

Conventional seed lists and/or plates can often be risky with respect to redundancy because anyone with a particular list or plate has easy access to the full key, and therefore access the individual's cryptocurrency funds. However, using an encryption kit configured according to various embodiments to store an individual's legitimate seed phrase in its encrypted form provides the individual with the benefit of being able to have many copies, in many places, with different custodians, without the concern of losing the individual's cryptocurrency funds from a compromised seed phrase. Further, by allowing multiple copies to be securely made and stored in multiple places (redundancy), various embodiments of the disclosure can address many concerns with respect to loss or destruction of the legitimate seed phase.

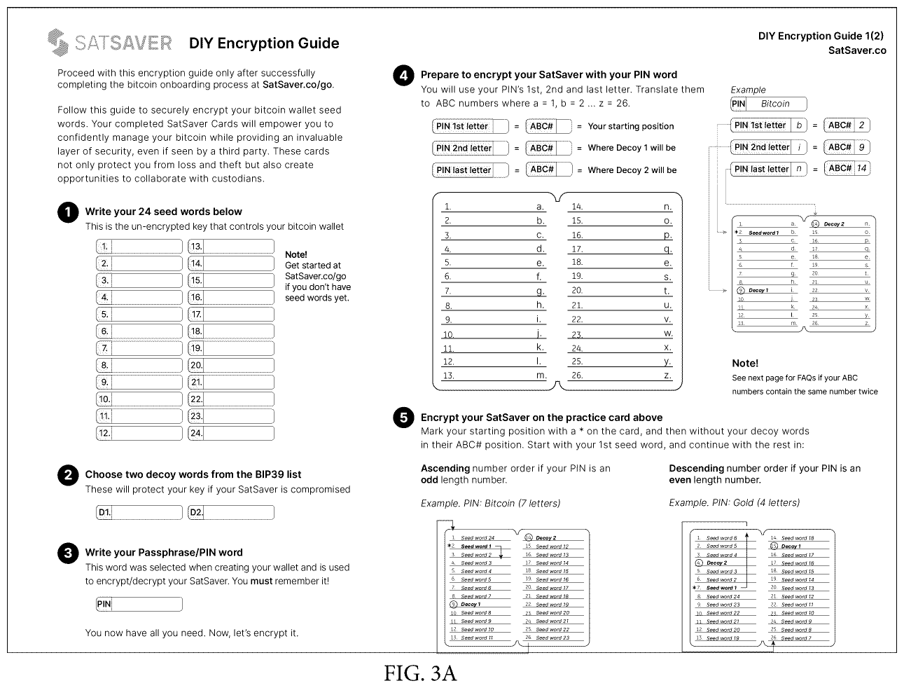

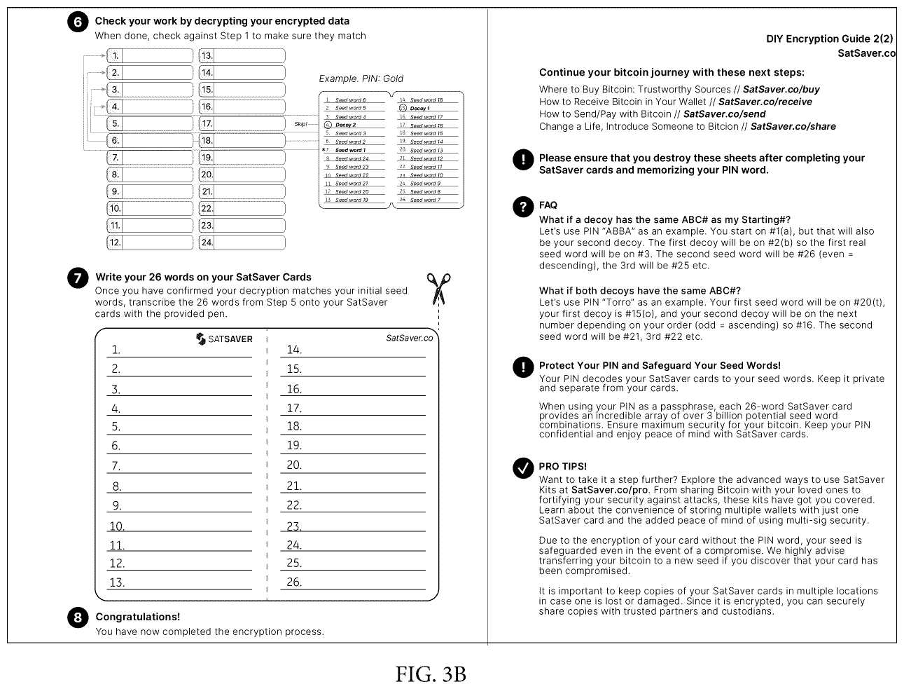

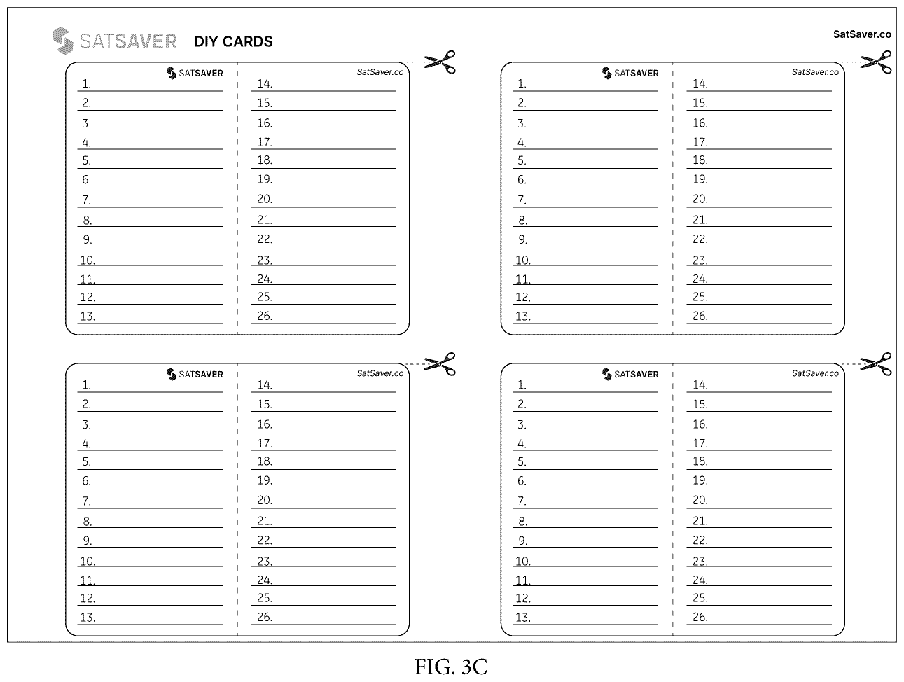

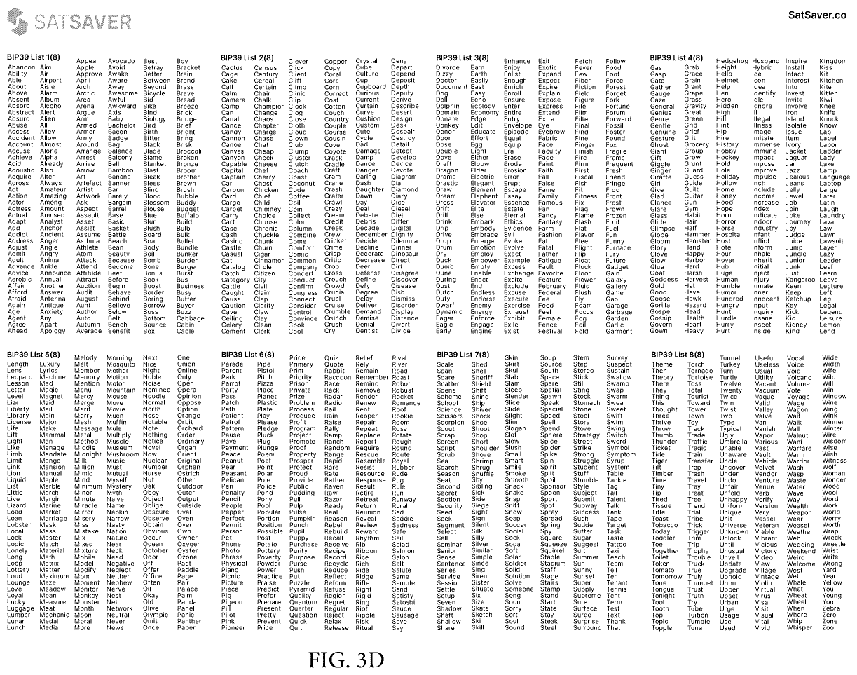

Particular embodiments provide the individual with a worksheet for generating an encrypted seed phrase. Accordingly, FIGS. 3A-3D depict an example of such a worksheet according to various embodiments. In this example, the worksheet, shown in FIG. 3A, provides an individual with step-by-step instructions for generating an encrypted seed phrase from a legitimate seed phrase. In addition, the worksheet, shown in FIG. 3B, provides the individual with some tips, warnings, and answers to common questions. Further, the worksheet provides the individual with a practice card and a final card for recording the encrypted seed phrase. FIG. 3C shows a set of practice cards, and FIG. 3D provides a set of words usable in creation of a seed phrase.

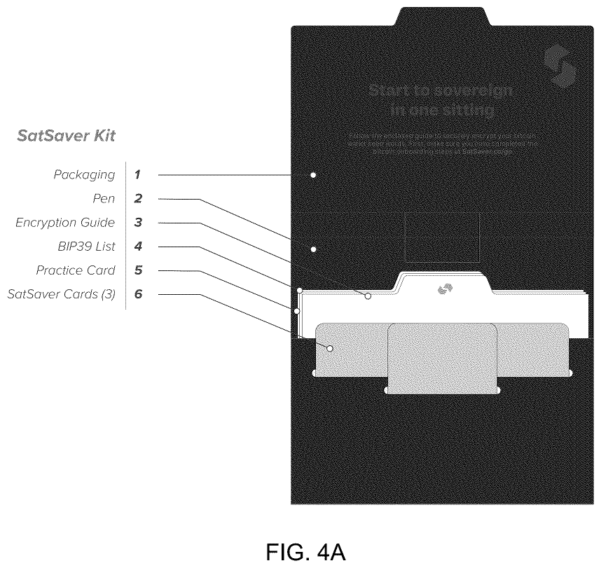

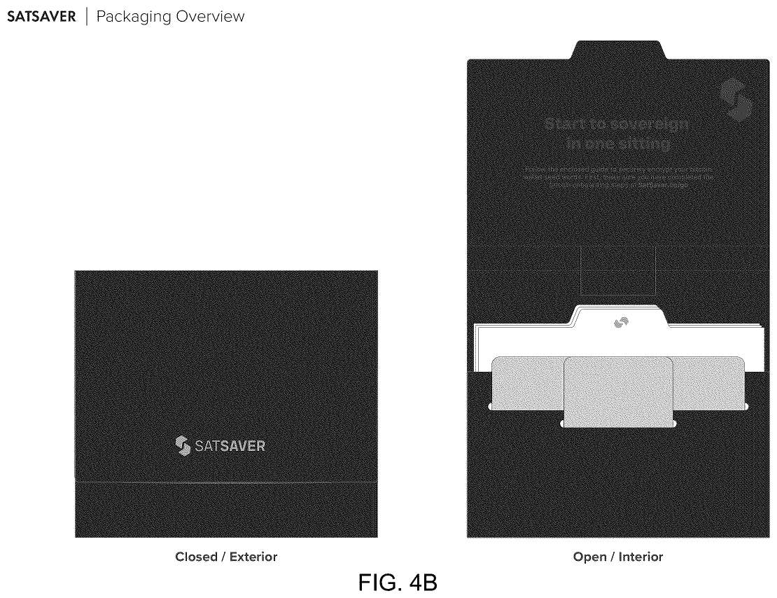

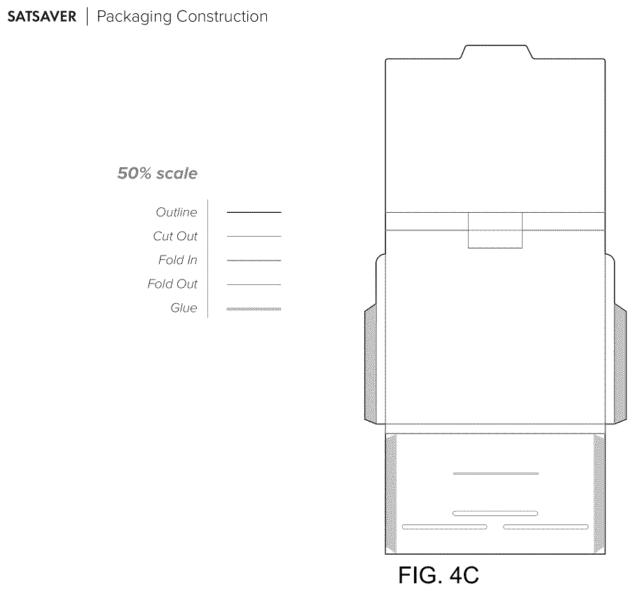

The instructions may be a part of an encryption kit that can be provided to individuals. Accordingly, FIGS. 4A-4C depict an example of an encryption kit according to various embodiments, in particular, a set of packaging for an encryption kit. FIG. 4A shows a configuration of a booklet that can be used for storing the encryption kit. As shown in this figure, the encryption kit storage device (i.e., packaging) includes an outer packaging, storage for a pen or other writing instrument, an encryption guide, one or more practice cards, and one or more seed phrase cards. As may be understood from FIGS. 4A-4C, the packaging may include one or more slots for storing each individual component of the encryption kit. FIGS. 4B-4C show the packaging in both an open and closed configuration, as well as a deconstructed version of the packaging (i.e., as shown in FIG. 4C.)

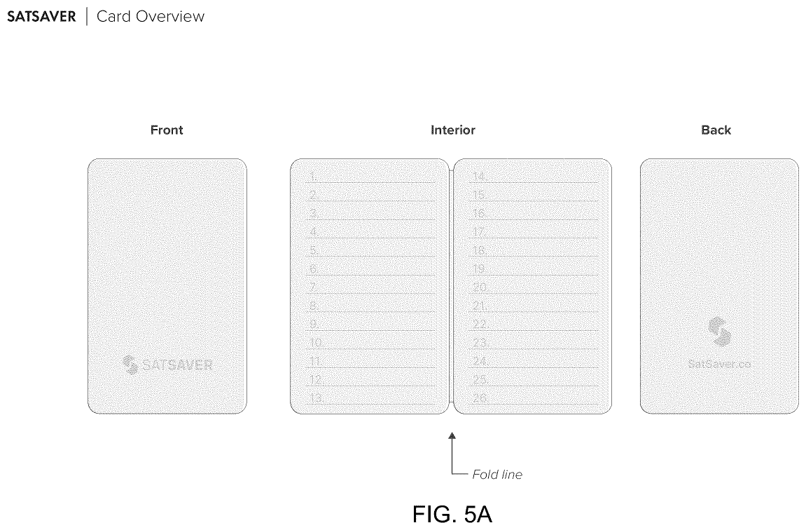

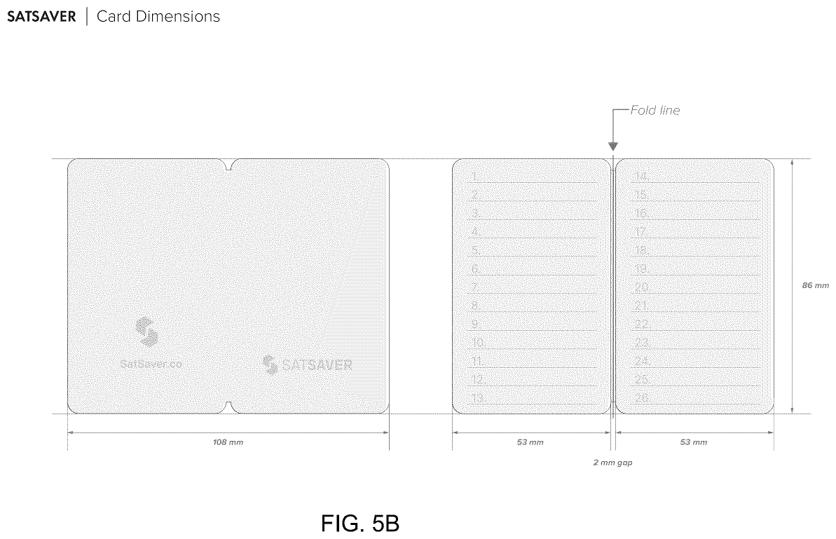

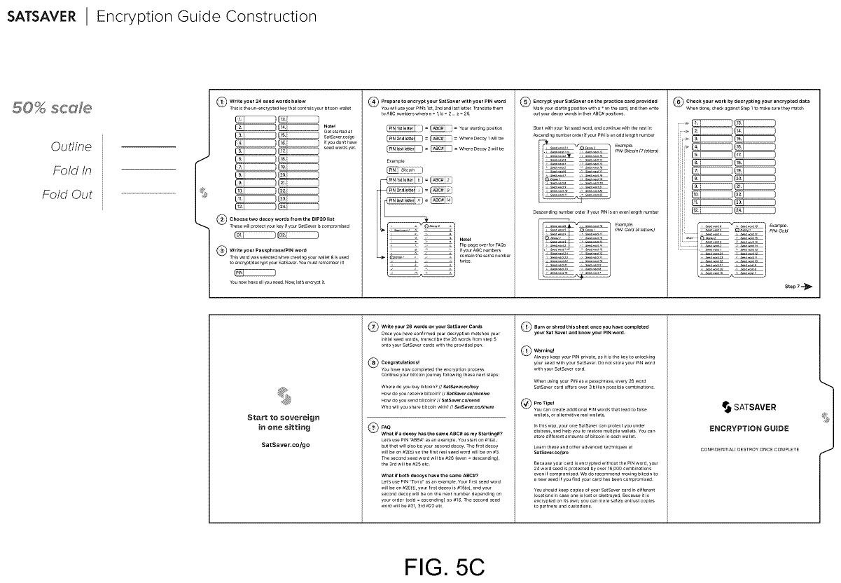

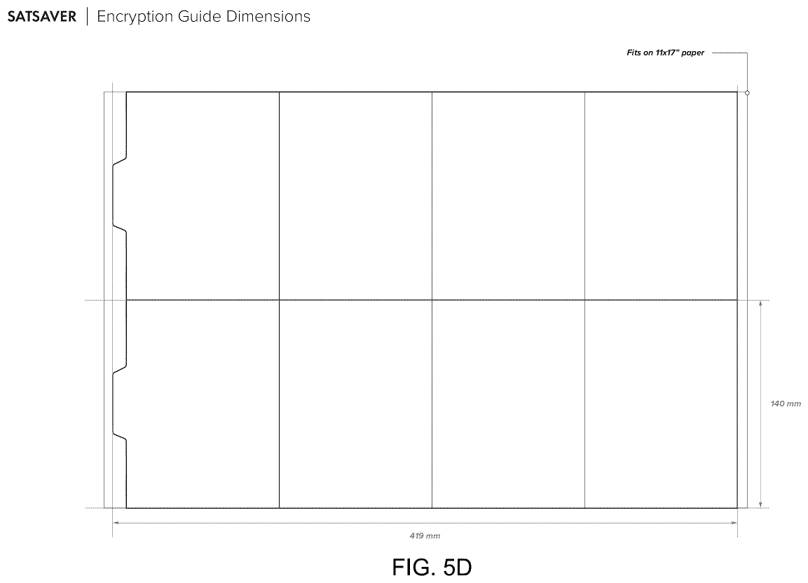

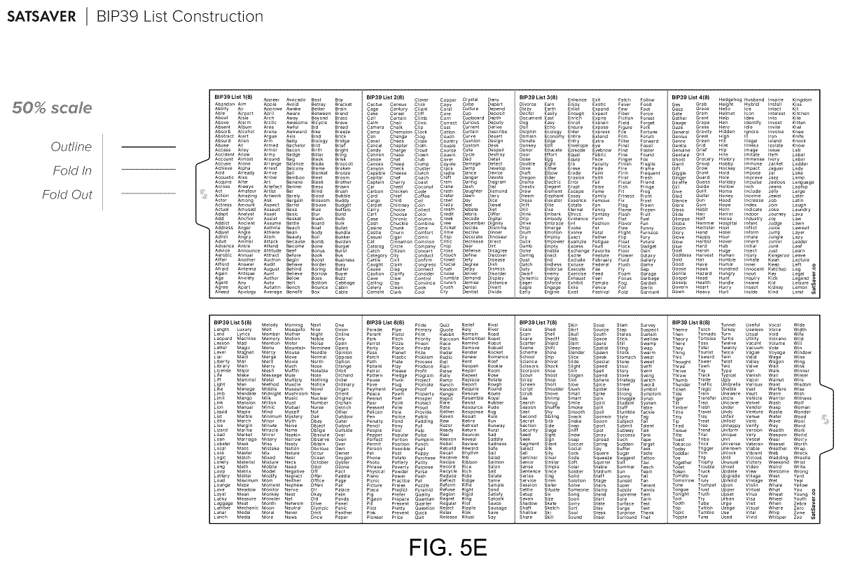

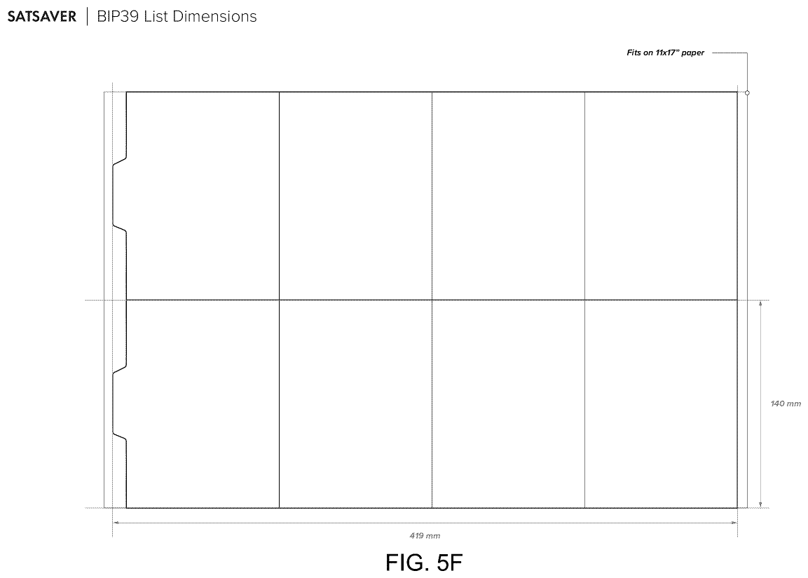

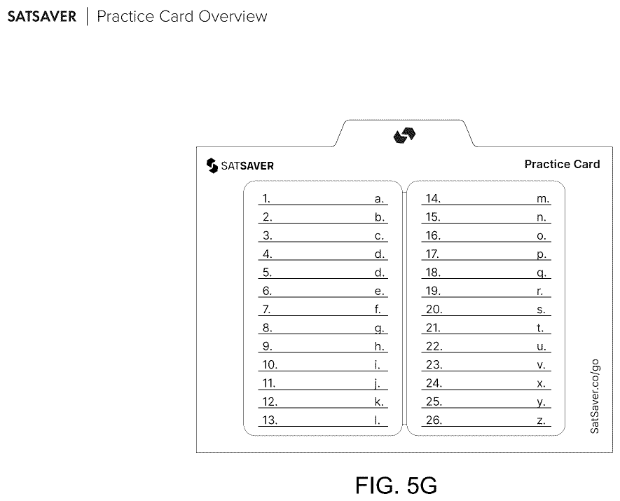

FIGS. 5A-5G depict exemplary contents of the encryption kit, which may include, for example, the contents of the booklet that can include the instructions, as well as a list of words that can be used for the seed phrase, decoy words, PIN word, and/or the like. In addition, the booklet can include saver cards that can be used in storing the encrypted seed phrase. The figures depict examples of various types of encrypted seed phrase saver cards in accordance with various embodiments. For example, such types can include center fold, plastic, carbon fiber, side fold, and textured TPU exterior. In other embodiments, the saver cards can comprise any other suitable material or configuration. In a particular embodiment, the saver card, as depicted in FIG. 5A, includes a substantially rectangular card (e.g., with rounded corners) that is foldable in the middle. Each portion of the saver card has a stack of parallel lines (e.g., 13 parallel lines) configured to enable a user to enter each of the 26 total words that make up the encoded seed phrase (i.e., the 24 word seed phrase that includes additional decoy words). In particular embodiments, the saver card, when folded, is approximately credit-card sized (e.g., for easy storage). Additionally, as shown in FIGS. 5C and 5D, the kit may include an instruction card that is substantially rectangular and quad-foldable (i.e., foldable into fourths) for storage within a corresponding slot in the packaging.

Ideally, the saver cards should be made of a material that does not degrade over time in storage, does not tear easily, does not fall apart if it gets wet, and/or the like. However, the saver cards do not necessarily need to be virtually indestructible (e.g., fireproof, chemical proof, crush proof, and/or the like) since encrypting of an individual's seed phrase according to various embodiments can allow the individual to produce multiple cards without worry of possibly exposing his or her legitimate seed phrase to an undesired party.

Further, conventional seed phrase cards are often made of some material that is selected to try and minimize the possibility of the cards being destroyed such as some type of metallic material. However, using metallic materials for seed phrase cards can pose a disadvantage for an individual when traveling because conventional cards can be problematic in discretely transporting the cards through certain security such as airport security. However, the encrypting of the seed phrase according to various embodiments allows for an individual to make numerous copies of the encrypted seed phrase that are secure from exposing the legitimate seed phrase. Therefore, various embodiments allow for the saver card to be made of a material that can allow for an individual to travel more discretely with his or her seed phrase. More specifically, an individual can travel with a saver card to various locations (e.g., internationally) without necessarily drawing attention while moving through security.

### Example Technical Platforms

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various embodiments, a non-volatile computer-readable storage medium may include a floppy disk, flexible disk, hard disk, solid-state storage (SSS) (e.g., a solid-state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various embodiments, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various embodiments are described to use a computer-readable storage medium, other types of computer-readable storage media may be substituted for or used in addition to the computer-readable storage media described above.

Various embodiments of the present disclosure may also be implemented as methods, apparatuses, systems, computing devices, computing entities, and/or the like. As such, various embodiments of the present disclosure may take the form of a data structure, apparatus, system, computing device, computing entity, and/or the like executing instructions stored on a computer-readable storage medium to perform certain steps or operations. Thus, various embodiments of the present disclosure also may take the form of entirely hardware, entirely computer program product, and/or a combination of computer program product and hardware performing certain steps or operations.

Various embodiments of the present disclosure are described below with reference to block diagrams and flowchart illustrations. Thus, each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some examples of embodiments, retrieval, loading, and/or execution may be performed in parallel such that multiple instructions are retrieved, loaded, and/or executed together. Thus, such embodiments can produce specially configured machines performing the steps or operations specified in the block diagrams and flowchart illustrations. Accordingly, the block diagrams and flowchart illustrations support various combinations of embodiments for performing the specified instructions, operations, or steps.

### Example System Architecture

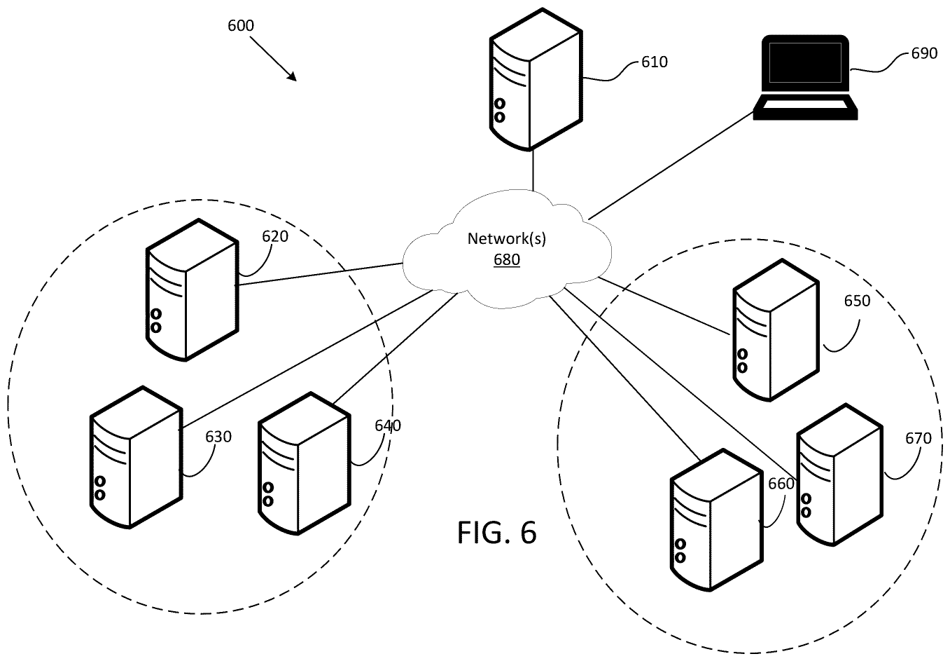

FIG. 6 is a block diagram of a system architecture 600 that can be used in configuring a blockchain wallet according to various embodiments of the disclosure as detailed herein. As shown, the system architecture 600 according to various embodiments may include a plurality of electronic devices 610-670. For example, the electronic devices 610-670 may be personal computers (PC), network servers, database servers, and/or the like. The electronic devices 610-670 may communicate with each other over a network 680 to form a blockchain network for the purpose of supporting a cryptocurrency platform. Here, each electronic device 610-670 can serve as a blockchain node to facilitate the blockchain network and support the cryptocurrency platform.

Accordingly, client devices 690 of individuals who are maintaining cryptocurrency funds on the cryptocurrency platform communicate with one or more of the blockchain nodes of the blockchain network via the network 680 to perform operations to facilitate transactions on the cryptocurrency platform such as reading and writing data in the blockchain via a corresponding blockchain node. More specifically, these individuals can have a blockchain wallet (e.g., hardware and/or software) that communicates with the blockchain nodes through their client devices 290 to facilitate such transactions. Further, the individuals can have the configure blockchain wallet module and/or the generate seed phrase module, as described herein, installed on their client devices 290 to configure the blockchain wallets with seed phrases that are secured through generating corresponding encrypted seed phrases.

### Example Computing Hardware

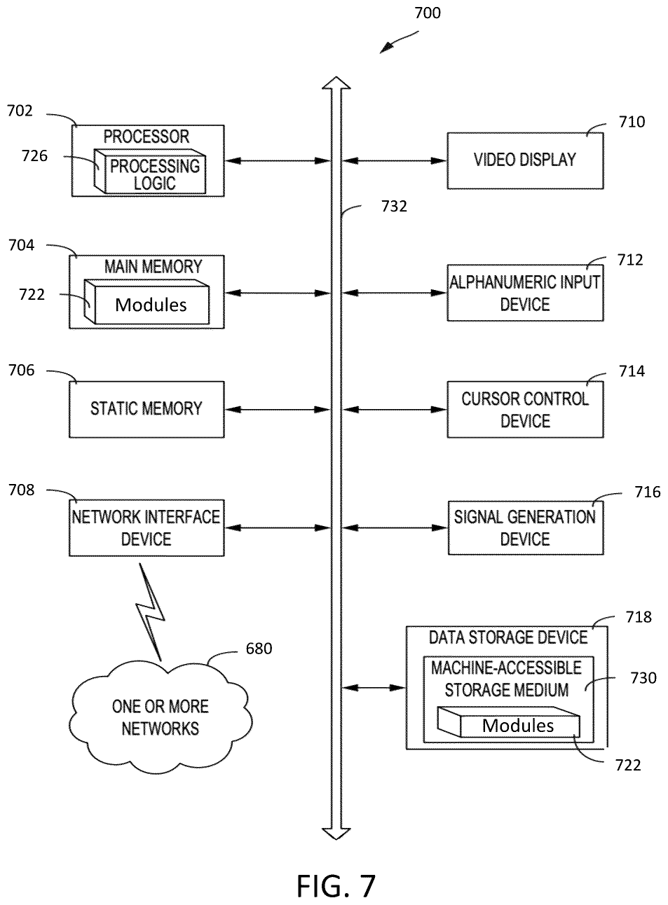

FIG. 7 illustrates a diagrammatic representation of a computing hardware device 700 that may be used in accordance with various embodiments of the disclosure. For example, the hardware device 700 may be computing hardware such as an electronic device 610-670 or a client device 690 as described in FIG. 6. According to particular embodiments, the hardware device 700 may be connected (e.g., networked) to one or more other computing entities, storage devices, and/or the like via one or more networks such as, for example, a LAN, an intranet, an extranet, and/or the Internet. As noted above, the hardware device 700 may operate in the capacity of a server and/or a client device in a client-server network environment, or as a peer computing device in a peer-to-peer (or distributed) network environment. According to various embodiments, the hardware device 700 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 700 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 700 includes a processor 702, a main memory 704 (e.g., read-only memory (ROM), flash memory, dynamic random-access memory (DRAM) such as synchronous DRAM (SDRAM), Rambus DRAM (RDRAM), and/or the like), a static memory 706 (e.g., flash memory, static random-access memory (SRAM), and/or the like), and a data storage device 718, that communicate with each other via a bus 732.

The processor 702 may represent one or more general-purpose processing devices such as a microprocessor, a central processing unit, and/or the like. According to some embodiments, the processor 702 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some embodiments, the processor 702 may be one or more special-purpose processing devices such as an application specific integrated circuit (ASIC), a field programmable gate array (FPGA), a digital signal processor (DSP), network processor, and/or the like. The processor 702 can execute processing logic 726 for performing various operations and/or steps described herein.

The hardware device 700 may further include a network interface device 708, as well as a video display unit 710 (e.g., a liquid crystal display (LCD), a cathode ray tube (CRT), and/or the like), an alphanumeric input device 712 (e.g., a keyboard), a cursor control device 714 (e.g., a mouse, a trackpad), and/or a signal generation device 716 (e.g., a speaker). The hardware device 700 may further include a data storage device 718. The data storage device 718 may include a non-transitory computer-readable storage medium 730 (also known as a non-transitory computer-readable storage medium or a non-transitory computer-readable medium) on which is stored one or more modules 722 (e.g., sets of software instructions) embodying any one or more of the methodologies or functions described herein. For instance, according to particular embodiments, the modules 722 include a configure blockchain wallet module and/or a generate seed phrase module as described herein. The one or more modules 722 may also reside, completely or at least partially, within main memory 704 and/or within the processor 702 during execution thereof by the hardware device 700—main memory 704 and processor 702 also constituting computer-accessible storage media. The one or more modules 722 may further be transmitted or received over a network 680 via the network interface device 708.

While the computer-readable storage medium 730 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 700 and that causes the hardware device 700 to perform any one or more of the methodologies of the present disclosure. The term “computer-readable storage medium” should accordingly be understood to include, but not be limited to, solid-state memories, optical and magnetic media, and/or the like.

### Blockchain Wallet Access Module

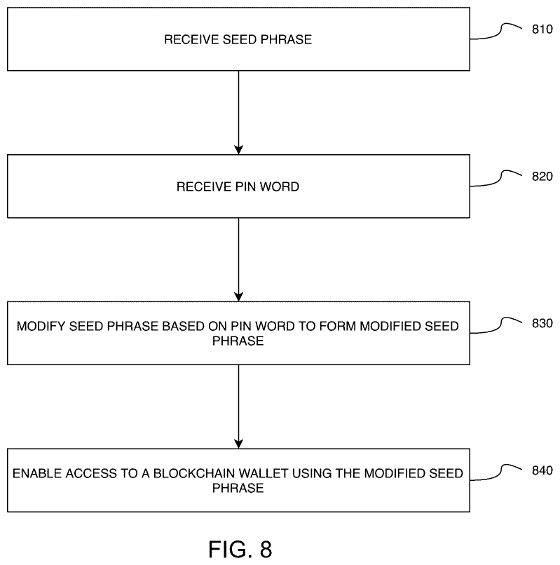

Turning to FIG. 8, additional details are provided regarding a blockchain wallet access module for accessing a blockchain wallet with a seed phrase to be used to access cryptocurrency funds through the wallet in accordance with various embodiments of the disclosure. For instance, the flow diagram shown in FIG. 8 may correspond to operations carried out, for example, by computing hardware as described herein, as the computing hardware executes the configure blockchain wallet module. In other aspects, the steps of FIG. 8 may correspond to method steps performed in order to code and/or decode a seed phrase for use with a blockchain wallet.

In particular aspects, the blockchain wallet access module begins, at step 810 by receiving a seed phrase. In some aspects, the blockchain wallet access module may receive the seed phrase via entry, via a computing device, of a seed phrase comprising twelve (plus one or more) or twenty-four (plus one or more) words. In various aspects, the blockchain wallet access module receives the encoded version of the seed phrase (i.e., an encoded, scrambled version of the seed phrase in an order other than the actual order of the seed phrase, having at least one word in addition to the worst that make up the seed phrase). Therefore, a computing device (e.g., via a user interface) may solicit an individual to indicate the fourteen or twenty-six words that make up the scrambled seed phrase. The user may, for example, access a suitable software application executing on a computing device (e.g., via a smartphone app or other suitable software application), and enter the scrambled seed phrase using a suitable input device (e.g., keyboard, touch-input device, etc.).

In some aspects, the blockchain wallet access wallet may receive, via a suitable imaging device (e.g., such as one or more mobile computing device cameras), an image of a saver card comprising the scrambled seed phrase. Computing hardware may then analyze the image using one or more optical character recognition (OCR) techniques to identify text within the image that includes the full scrambled seed phrase. In some embodiments, the computing hardware is configured to use any suitable data capture technique (e.g., OCR technique to): (1) identify two adjacent columns of words in the image; (2) determine that the two adjacent columns of words contain an expected number of words that make up a scrambled seed phrase (i.e., two columns of thirteen words each); and (3) construct the scrambled seed phrase from the identified set of words.

In still other aspects, the system may store the seed phrase (e.g., in a computing device such as a user's smartphone).

At step 820, the computing hardware may receive the PIN word. The PIN word may, for example, define a manner in which the computing hardware, in the context of executing the blockchain wallet access module, is to descramble (i.e., decrypt) the scrambled seed phrase. For example, in various embodiments, a position of particular letters within the PIN word may identify which words in the scrambled seed phrase should be omitted when decrypting the scrambled seed phrase. In other aspects, particular letters in particular positions within the PIN word may cause the computing hardware to place the set of words in the scrambled seed phrase in a different order based on the letter and position within the PIN word when decrypting the seed phrase.

The computing hardware may receive the PIN word in any suitable manner, for example, from a user inputting the PIN word in a suitable computing device, via one or more OCR techniques, etc.

At Step 830, the computing hardware modifies the seed phrase (i.e., scrambled seed phrase) received at Step 810 based on the PIN word. The computing hardware may modify the scrambled seed phrase using any suitable technique described herein. For example, the computing hardware may reorder the scrambled seed phrase, omit one or more words from the scrambled seed phrase, etc. in order to generate a decrypted seed phrase. In a particular embodiment, the system may decrypt the seed phrase according to one or more sets of instructions in the figures, such as in FIGS. 3A-3B, etc. At Step 840, the computing hardware may enable access to a blockchain wallet using the modified, decrypted seed phrase. For example, the computing hardware may automatically provide the seed phrase to the blockchain wallet, the computing hardware may display the decrypted seed phrase on a graphical user interface on a computing device, etc. In some aspects, the blockchain wallet may incorporate software configured to decrypt scrambled seed phrases based on PIN words as described herein.

### Exemplary Saver Cards

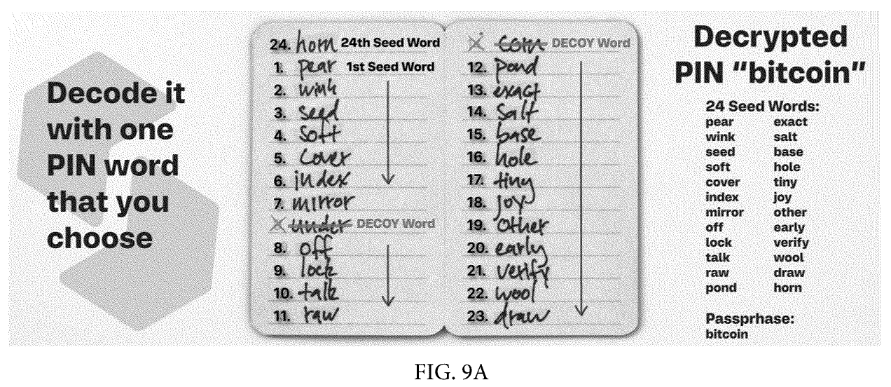

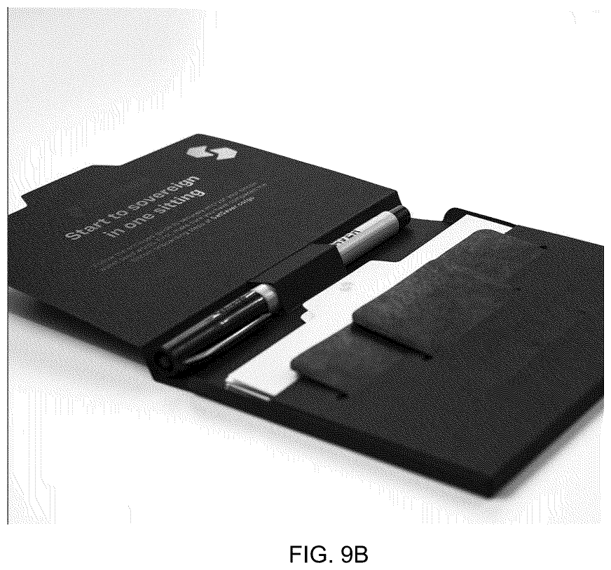

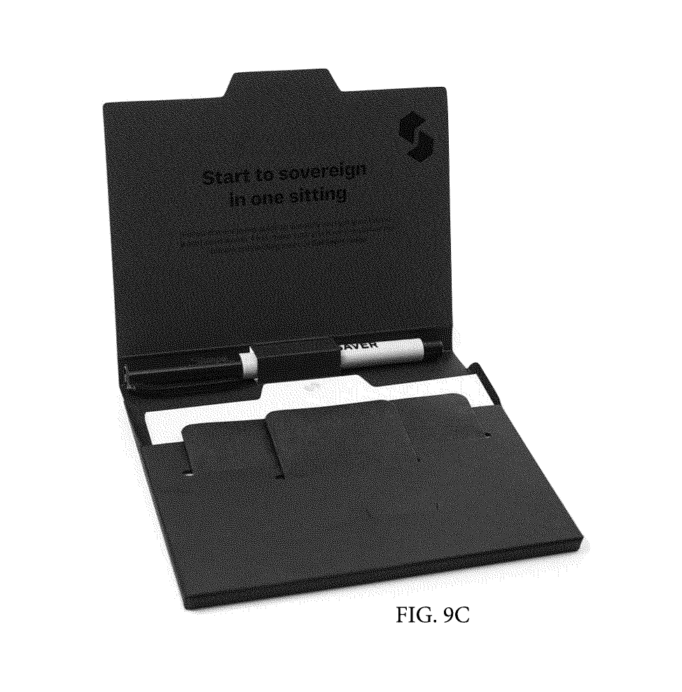

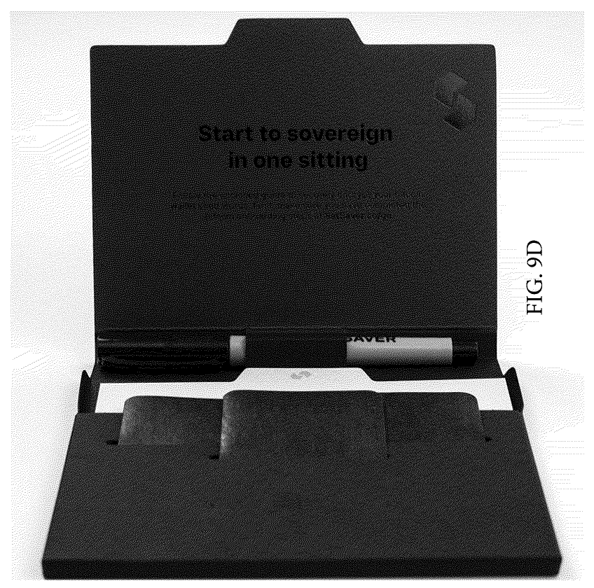

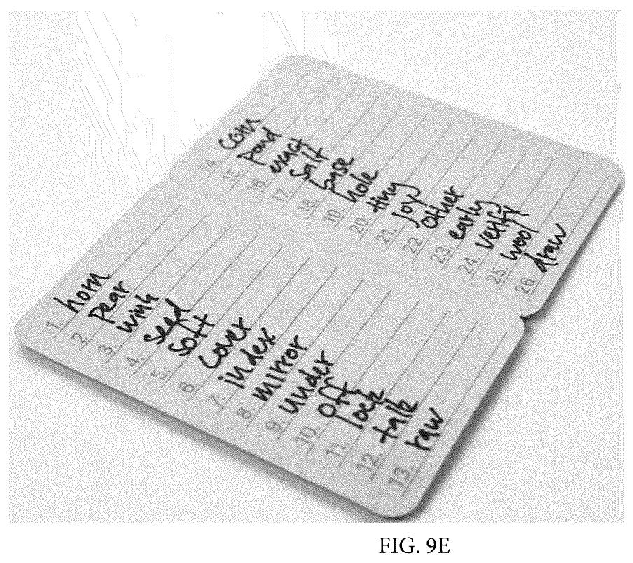

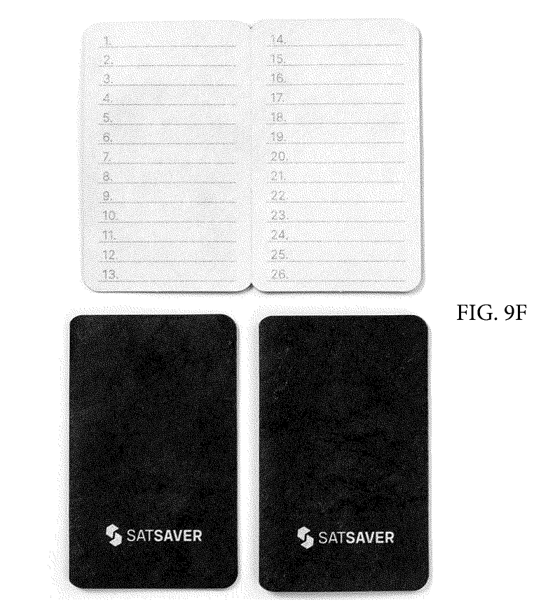

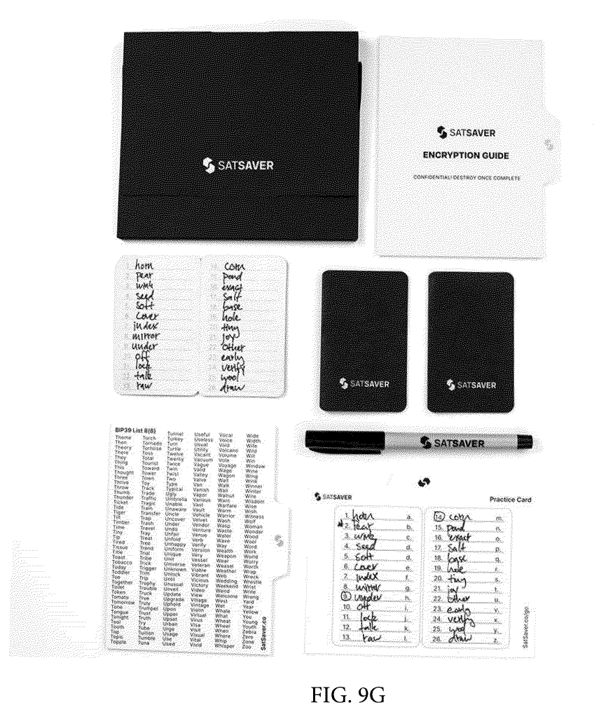

FIGS. 9A-9G depict exemplary images of a saver card kit (i.e., encryption kit) according to various embodiments. As may be understood from these figures, the encryption kit comprises a worksheet for generating an encrypted seed phrase. The worksheet may, for example, provide an individual with step-by-step instructions for generating an encrypted seed phrase from a legitimate seed phrase. In addition, the worksheet, as part of the encryption kit, provides the individual with some tips, warnings, and answers to common questions. Further, the worksheet provides the individual with a practice card and a final card for recording the encrypted seed phrase. FIGS. 9A-G shows a set of practice cards, a set of words usable in creation of a seed phrase, a saver card, pen, and packaging that make up the kit. The instructions may be a part of an encryption kit that can be provided to individuals. The figures depict a configuration of a booklet that can be used for storing the encryption kit. As shown in this figure, the encryption kit storage device (i.e., packaging) includes an outer packaging, storage for a pen or other writing instrument, an encryption guide, one or more practice cards, and one or more seed phrase cards. As may be understood from the figures, the packaging may include one or more slots for storing each individual component of the encryption kit such that the packaging receives each component of the kit in stored form.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific embodiment details, these should not be construed as limitations on the scope of any invention or of what may be claimed, but rather as descriptions of features that may be specific to particular embodiments of particular inventions. Certain features that are described in this specification in the context of separate embodiments also may be implemented in combination in a single embodiment. Conversely, various features that are described in the context of a single embodiment also may be implemented in multiple embodiments separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various embodiments described above should not be understood as requiring such separation in all embodiments, and the described program components (e.g., modules) and systems may be integrated together in a single software product or packaged into multiple software products.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for the purposes of limitation.

1. A method comprising:
generating a legitimate seed phrase, wherein the legitimate seed phrase comprises a sequence of legitimate words;
identifying, based on a PIN word, a starting position within an encrypted seed phrase of a first word found in a first position in the sequence of legitimate words;
identifying, based on the PIN word, at least one position of at least one decoy word within the encrypted seed phrase;
identifying, based on the PIN word, a direction in which the sequence of legitimate words proceeds within the encrypted seed phrase;
generating the encrypted seed phrase, wherein the encrypted seed phrase comprises the first word found in the first position in the sequence of legitimate words in the starting position, the at least one decoy word in the at least one position, and the sequence of legitimate words proceeding in the direction to form a sequence of encrypted words; and
configuring, based at least in part on the legitimate seed phrase, a blockchain wallet to access cryptocurrency funds for an individual via the legitimate seed phrase.

2. The method of claim 1 further comprising:
decrypting, based on the PIN word, the encrypted seed phrase to identify the sequence of legitimate words for the legitimate seed phrase; and
accessing, based on the legitimate seed phrase, the cryptocurrency funds through the blockchain wallet.

3. The method of claim 1, wherein:
the sequence of encrypted words comprises a sequence of twenty-six words,
the sequence of legitimate words comprises a sequence of twenty-four words,
the at least one decoy word comprises two decoy words, and
the encrypted seed phrase comprises:
the sequence of twenty-six words that comprise the sequence of twenty-four words with the two decoy words embedded within the sequence of twenty-four words,
the starting position containing the first word found in the first position in the sequence of twenty-four words; and
the sequence of twenty-four words proceeds within the sequence of twenty-six words in the direction.

4. The method of claim 3, wherein each position of the sequence of twenty-six words corresponds to a letter of an alphabet, the starting position is based on a first letter of the PIN word, and the PIN word comprises at least two letters.

5. The method of claim 4, wherein a position of the first decoy word in the sequence of twenty-six words is based on a second letter of the PIN word, and a position of the second decoy word in the sequence of twenty-six words is based on a last letter of the PIN word.

6. The method of claim 5, wherein the direction in which the sequence of twenty-four words proceeds within the sequence of twenty-six words is forward if the PIN word includes an even number of letters or backward if the PIN word includes an odd number of letters.

7. A method comprising:
receiving, by computing hardware, a first seed phrase comprising a first set of words in a first order;
receiving, by the computing hardware, a PIN word;
modifying, by the computing hardware, the first seed phrase into a second seed phrase by:
identifying, based on at least one letter in a first position of the PIN word, a second set of words from the first set of words, the second set of words comprising at least one fewer word than the first set of words;
determining, based on at least one second letter in a second position of the PIN word, a second order for the second set of words; and
generating, by the computing hardware based on the PIN word, the second seed phrase comprising the second set of words in the second order; and
enabling, by the computing hardware, access to a blockchain wallet through operation of the second seed phrase.

8. The method of claim 7, wherein receiving the first seed phrase comprises:
receiving an image; and
analyzing the image using one or more optical character recognition techniques to identify the first seed phrase in the image.

9. The method of claim 8, wherein analyzing the image using one or more optical character recognition techniques to identify the first seed phrase in the image comprises:
analyzing the image to identify a first column of words and a second column of words adjacent the first column of words; and
extracting the first seed phrase from the first column of words and the second column of words.

10. The method of claim 7, wherein determining, based on the at least one second letter in the second position of the PIN word, the second order for the second set of words comprises arranging the second set of words beginning with a first word identified by the at least one second letter and arranging the second set of words in a direction defined by a number of letters in the PIN word.

11. The method of claim 7, wherein identifying the second set of words from the first set of words, comprises omitting at least one word from the first set of words in a position defined by that at least one letter in the first position.

12. The method of claim 7, wherein the first set of words comprises twenty six words and the second set of words comprises twenty four words.

13. The method of claim 7, wherein enabling, by the computing hardware, access to the blockchain wallet through operation of the second seed phrase comprises providing the second seed phrase to the blockchain wallet.

14. The method of claim 7, wherein enabling, by the computing hardware, access to the blockchain wallet through operation of the second seed phrase displaying the second seed phrase on a display screen of a computing device.

15. A kit for use in generating an encrypted seed phrase, the kit comprising:
a set of instructions;
a saver card comprising a first stack of parallel lines and a second stack of parallel lines spaced apart from the first stack of parallel lines, wherein:
the first stack of parallel lines is parallel to the second stack of parallel lines; and
the saver card defines a fold between the first stack of parallel lines and the second stack of parallel lines;
one or more practice cards, at least a portion of each of the one or more practice cards duplicating at least a portion of the saver card; and
packaging configured to receive the set of instructions, the saver card, and the one or more practice cards, wherein:
the kit is configured to enable a user to generate the encrypted seed phrase according to the set of instructions by:
generating an initial seed phrase;
selecting at least one decoy word;
selecting a PIN word;
encrypting the initial seed phrase by inserting the at least one decoy word into the initial seed phrase at a position defined by the PIN word;
rearranging the initial seed phrase including the at least one decoy word into an order defined by the PIN word to form the encrypted seed phrase; and
recording the encrypted seed phrase on the saver card by writing each word of the encrypted seed phrase on a respective line of first stack of parallel lines and the second stack of parallel lines.

16. The kit of claim 15, wherein the first stack of parallel lines and the second stack of parallel lines comprise thirteen parallel lines.

17. The kit of claim 15, wherein the at least one decoy word comprises two decoy words.

18. The kit of claim 15, wherein the encrypted seed phrase comprises twenty six words.

19. The kit of claim 15, wherein:
the packaging defines a first slot configured to receive the saver card and a second slot configured to receive the set of instructions.

20. The kit of claim 15, wherein the saver card, when folded along the fold between the first stack of parallel lines and the second stack of parallel lines is sized, shaped, and dimensioned approximately like a credit card.
